(19) United States
(12) Patent Application Publication
(10) Pub. No.: US 2008/0104879 A1
(43) Pub. Date: May 8, 2008

(54) Stick-on bait

(76) Inventor: Douglass A. Poppe, Mentone, CA (US)

Correspondence Address: Karl M. Steins;Steins & Associates, Suite 120, 2333 Camino del Rio South, San Diego, CA, 92108, US

(21) Appl. No.: 11/591,962

(22) Filed: Nov. 2, 2006

(51) Int. Cl. A01K 85/00; A01M 31/06

(52) U.S. Cl. 43/42.32; 43/2; 43/4; 43/42; 43/42.24

(57) ABSTRACT

Stick-on Bait is disclosed. The bait is configured to be applied to submerged portions of a boat hull where swimming fish in the vicinity can view them. The bait includes a flexible substrate and a fish-attracting design on its outer side. The back side includes a water-proof adhesive material. The bait is shaped like a small fish in two dimensions. The outer surface may further have a metallic film providing a kaleidoscopic pattern therein.

### BACKGROUND OF THE INVENTION

1. Field of the Invention

This invention relates generally to sport fishing tools and accessories and, more specifically, to Stick-on Bait.

2. Description of Related Art

Bait and lures are available in a virtually infinite variety of types, styles, shapes and sizes. All of these devices have one thing in common—they are intended to be attached to the fishing line or within the fishing net to attract the fish into biting the hook or getting caught in the net. Although “chumming” (dumping fish entrails into the water) attracts fish, none of the previous lures or baits is designed to attract the fish to the boat on a repeated basis (without the need to re-chum).

What is needed, then, is a bait or lure that is associated with the boat to attract fish to the vicinity of the boat.

### SUMMARY OF THE INVENTION

In light of the aforementioned problems associated with the prior devices and methods, it is an object of the present invention to provide Stick-on Bait. The bait should be configured to be applied to submerged portions of a boat hull where swimming fish in the vicinity can view them. The bait should include a flexible substrate and a fish-attracting design on its outer side. The back side should include a water-proof adhesive material. The bait should be shaped in two dimensions like a small fish. The outer surface may have a metallic film providing a kaleidoscopic pattern therein.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIGS. 1A and 1B are front perspective and rear perspective views of a preferred embodiment of the stick-on bait of the present invention;

FIG. 2 is a perspective view depicting how the devices of the present invention are applied to a boat;

FIG. 3 is a bottom view of the boat of FIG. 2 having several of the devices of FIGS. 1A and 1B adhered thereto; and

FIG. 4 is a perspective view depicting the effect of the device on the present invention on fish in the vicinity of the boat.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide Stick-on Bait.

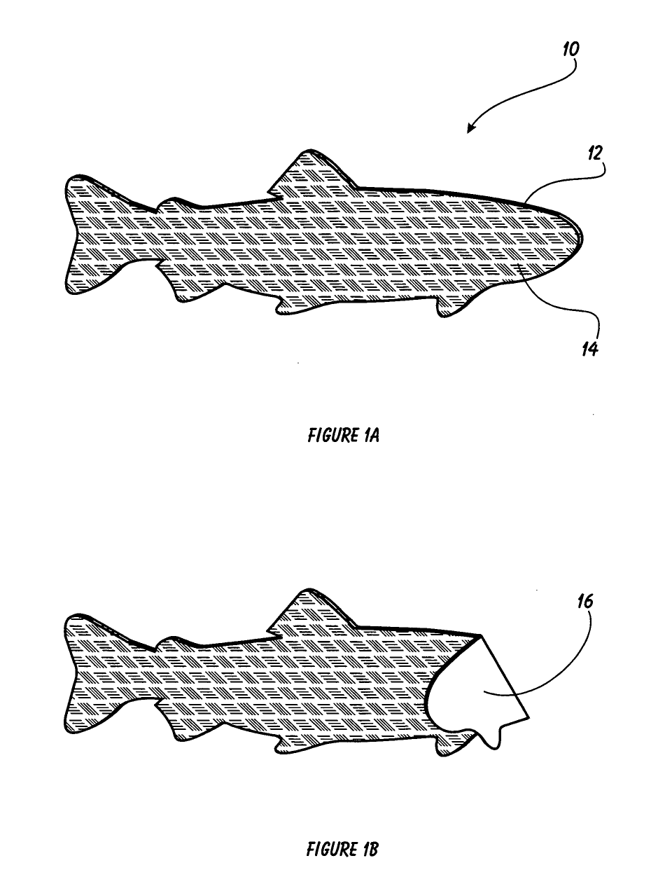

The present invention can best be understood by initial consideration of FIGS. 1A and 1B. FIGS. 1A and 1B are front perspective and rear perspective views of a preferred embodiment of the stick-on bait 10 of the present invention. The bait 10 has a substrate 12, such as coated paper, plastic or other durable, waterproof, flexible material. The front surface 14 of the substrate 12 is coated with a fish-attracting pattern, coating or film. One example of the film version is a mirrored, kaleidoscope-patterned material. The point is that the surface 14 has an appearance that is easily noticed (visually) by fish swimming in its vicinity, and that is found attractive to these fish.

The rear surface 16 of the substrate has an adhesive material applied to it. The adhesive is preferably strong enough to enable the bait 10 to be applied to a surface that will be under water for long periods of time without releasing from the surface to which it has been applied. In fact, it would be preferred if the adhesive was of the type that necessitated a special solvent to remove the bait 10 from the surface to which it was stuck. The bait may be purchased in sheets, having a backing paper (e.g. similar to wax paper and the like). The user need simply to peel individual bait stickers off of the backing sheet and apply them to the desired surface for display.

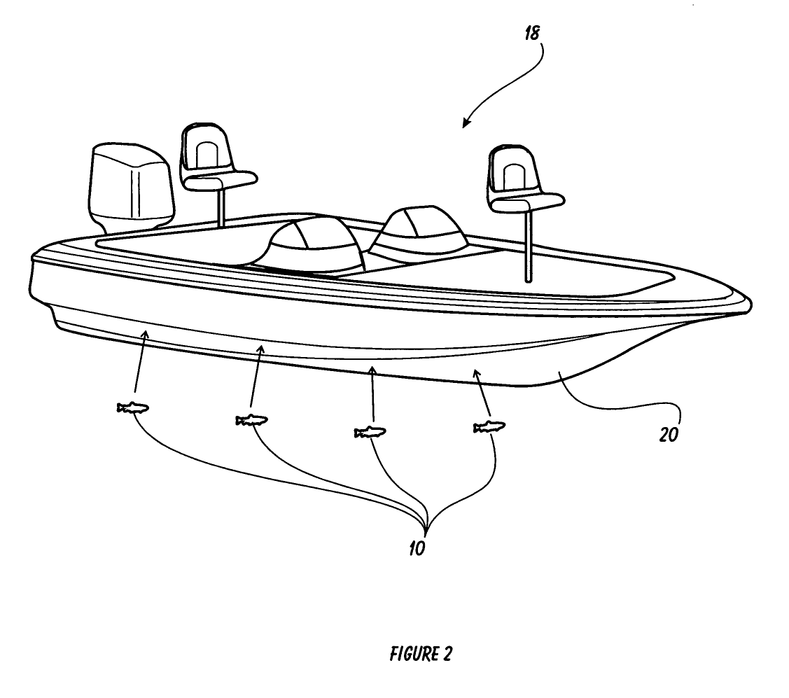

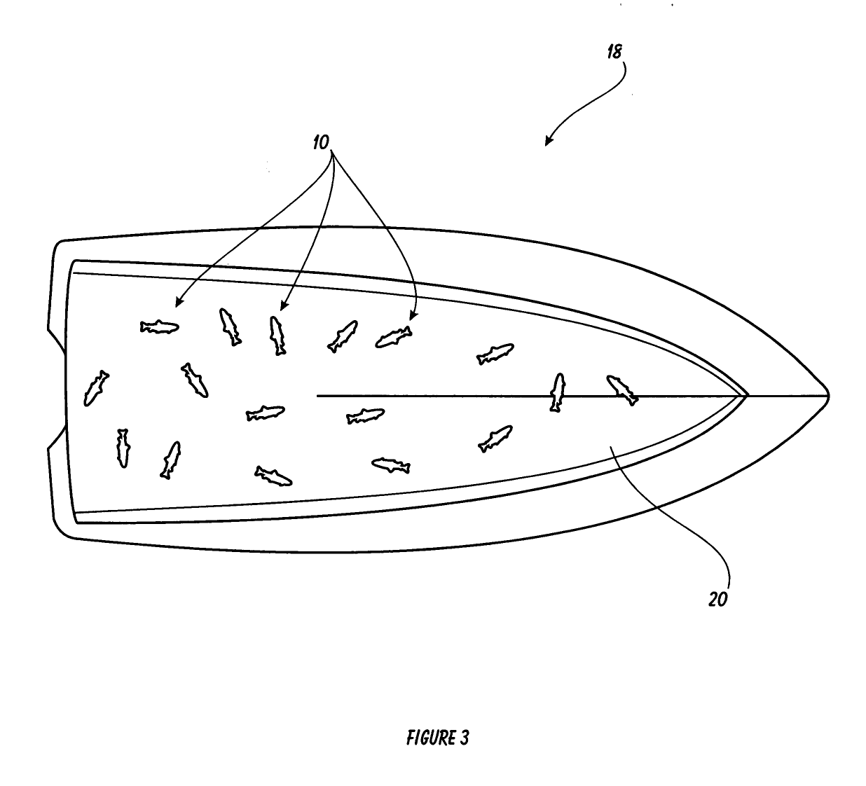

FIG. 2 is a perspective view depicting how the devices of the present invention 10 are applied to a boat 18. The user need simply apply several of the bait stickers 10 to the wetted area of the hull surface 20 of the boat 18. If one viewed the boat 18 from the bottom, it would look similar to FIG. 3.

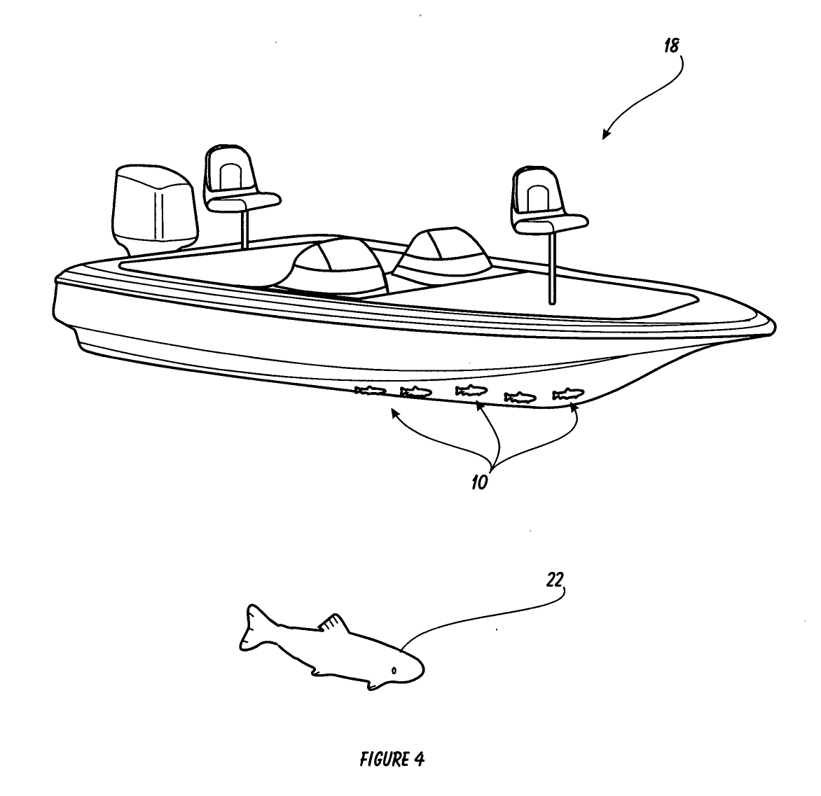

FIG. 3 is a bottom view of the boat 18 of FIG. 2 having several of the devices of FIGS. 1A and 1B adhered thereto. As shown, as many of the bait stickers 10 can be applied, in any desired configuration, to the hull surface 20. As depicted in FIG. 4, when the boat 18 is in the water, the bait stickers 10 will be visible from the bottom of the boat 18 by fish swimming in the vicinity of the boat 18. Testing reveals that the bait stickers 10 are very effective at attracting fish 22 to the area of the boat. Once fish 22 group around the boat 18, it improves the odds for the fisherman that fish will be caught.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

1. A fishing lure, comprising:
a backing sheet:
a flexible substrate sheet defined by a front surface and a rear surface;
a fish-attractive design applied to said front surface;
adhesive coating applied to said rear surface, said adhesive coating and said backing sheet of the type that permits said flexible substrate sheet to be removed from said backing sheet.

2. The lure of claim 1, wherein said flexible substrate sheet is in the shape resembling a fish.

3. The lure of claim 2, wherein said fish-attractive design comprises a metallic film bonded to said front surface.

4. The lure of claim 3, wherein said metallic film further comprises a kaleidoscopic pattern formed thereon.

5. A fishing lure system, comprising:
a backing sheet having a non-stick top surface;
a plurality of fishing lures attached to said non-stick top surface, each said fishing lure comprising:
a flexible substrate sheet defined by a front surface and a rear surface;
a fish-attractive design applied to said front surface; and
adhesive coating applied to said rear surface, said adhesive coating attaching said fishing lures to said non-stick top surface, and said adhesive and said cooperating such that said fishing lures are removable from said backing sheet without destroying the adhesive properties of said adhesive.

6. The system of claim 5, wherein said substrate sheet is made from a waterproof material.

7. The system of claim 6, wherein each said lure is in the shape resembling a fish.

8. The system of claim 7, wherein said fish-attractive design comprises a metallic film bonded to said front surface.

9. The system of claim 8, wherein said metallic film further comprises a kaleidoscopic pattern formed thereon.

10. A method for attracting fish, comprising the step of:
attaching at least one bait sticker to a hull surface of a boat, where said attaching is to a portion of said hull surface that can be viewed from below the boat, each said bait sticker comprising:
a flexible substrate sheet defined by a front surface and a rear surface;
a fish-attractive design applied to said front surface; and
adhesive coating applied to said rear surface.

11. The method of claim 10, wherein said sheet is a waterproof material.

12. The method of claim 11, wherein said sheet is in the shape resembling a fish.

13. The method of claim 12, wherein said fish-attractive design comprises a metallic film bonded to said front surface.

14. The method of claim 13, wherein said metallic film further comprises a kaleidoscopic pattern formed thereon.
